(19) United States
(12) Patent Application Publication
(10) Pub. No.: US 2004/0154153 A1
(43) Pub. Date: Aug. 12, 2004

(54) Process for making molds

(76) Inventors: Iberio E. Scanni, Mississauga (CA); Nino Scanni, Mississauga (CA)

Correspondence Address: IBERIO E. SCANNI, 5199 WARWICKSHIRE WAY, MISSISSAUGA, ON, L5V-IN5, CA

(21) Appl. No.: 10/361,423

(22) Filed: Feb. 11, 2003

(51) Int. Cl. B23P 11/00

(52) U.S. Cl. 29/428

(57) ABSTRACT

A process of making molds and inserts where each mold or insert consists of superimposed plates, tightly secured together, having the hollow form(s) or pattern(s) been cut in place. The hollow form(s) or pattern(s) were cut by means of laser or similar cutting machine, which is not possible to do in the blanks or solid pieces that are used to make most molds or inserts because the material to be cut is too thick.

The preferred height of the mold or insert was reached by using the proper amount of plates.

Superimposed plates with pre-cut pattern(s) can easily be used to make any mold or insert despite its thickness or the intricacies of the pattern(s).

### BRIEF DESCRIPTION OF THE DRAWINGS

FIG. 1 is a perspective view of one mold or insert made with the process of fabrication of the present invention;

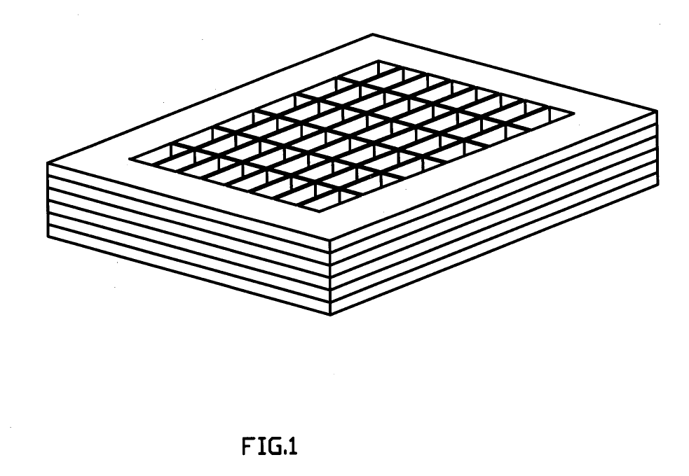

FIG. 2 is a top elevational view of one mold or insert made with the process of fabrication of the present invention where the plate 1, same as the other plates that are underneath, has a total of forty eight hollow forms or cut out patterns 2 in place;

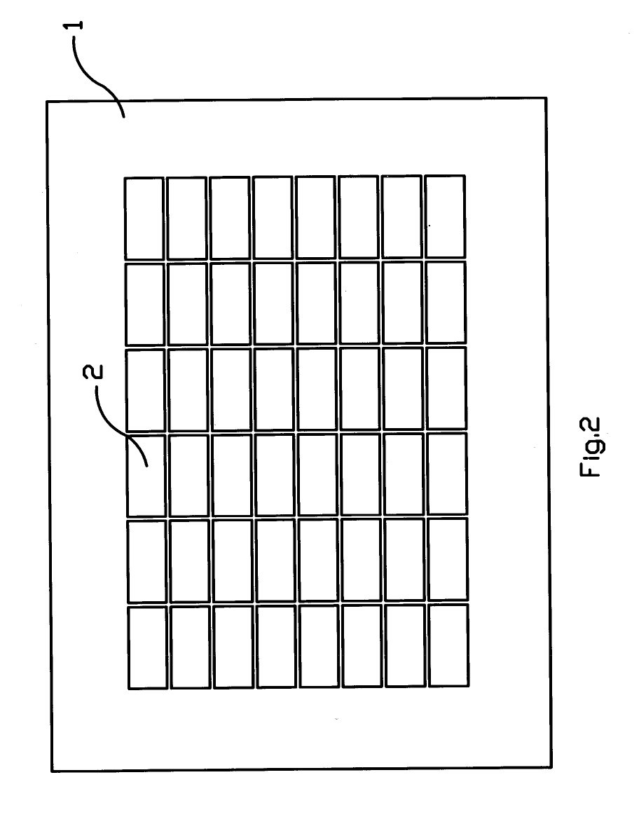

FIG. 3 is a side elevational view of the mold or insert of FIG. 1 showing several layers of plates 1 with the cut out patterns 2 in place and with the plates welded or fastened together.

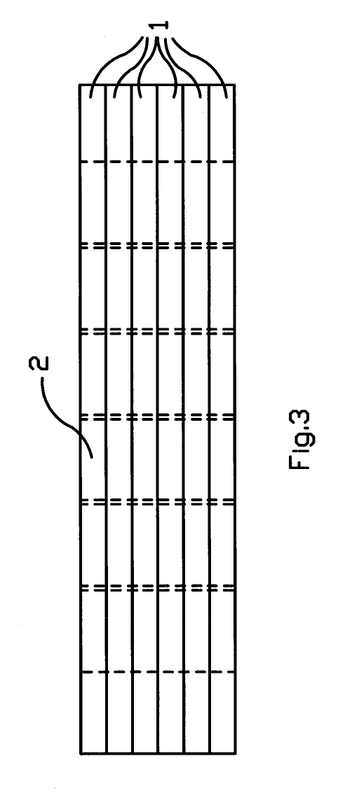

This invention relates to a process of fabrication of molds and inserts for the replication of patterns.

The process of fabrication of molds and inserts by which each mold or insert is comprised by two or more plates superimposed congruently and welded or fastened together to obtain a predetermined thickness as if such mold or insert was made from a blank or a solid piece of the material desired; where in such plates were previously made in place the hollow forms or cut outs with the shape(s) or pattern(s) to be reproduced. Before any assembly work was done, the plates were ground; machined or cut to size and the cut out shape(s) or pattern(s) were made at the corresponding places in each plate using laser, or similar cutting machine.

This easy and accurate process of making molds and inserts permits to reproduce intricate shapes or patterns in concrete or any other plastic or molten material with great detail. Each plate had points of reference at specific places that were used in all the machining and final assembly of the mold. Some of the reference points were holes drilled through in each plate near the corners. The same reference holes were used later during the assembly work. In each hole was inserted, once the plates were in position, a rod of the proper size. Each rod was welded or fastened against the previously countersunk or machined holes located in the exposed face of the upper and lower plates that form the mold or insert, respectively.

The welding of the plates between themselves was done according to Industry Standards.

We claim:

1. A process for the fabrication of molds and inserts where each mold or insert is comprised by a plurality of plates superimposed congruently with the hollow form(s) or cut out pattern(s) in place, wherein:
said plates were machined or cut to size,
said plates surfaces were ground for the purpose of a perfect fitting when assembled,
said plates were welded or fastened together in order to obtain the desired thickness, in said plates the hollow(s) or cut outs were made at the corresponding places with the desired final pattern(s) or shape(s).

2. A process according to claim 1, wherein the plates were congruently welded or fastened together to form a mold or insert.

3. A process according to claim 1, characterized in that the mold or insert was fabricated with the purpose of giving a particular shape to something in a molten or plastic state.

4. A process according to claim 1, where the mold is used for the fabrication of concrete pieces like paving stones, bricks, blocks, tiles, retaining walls, curbs as well as any pre-cast piece, wherein:
said mold is comprised of a lower, upper and a central part or insert,
said central part or insert that makes the walls of the pattern(s) or shape(s) of the mold was fabricated according to the process of claim 1,
the hollow(s) or cut outs that form said pattern(s) or shape(s) in all the plates of the insert, that were congruently superimposed, form an open cavity(ies) from top to bottom once in place.
